(19) United States
(12) Patent Application Publication
(10) Pub. No.: US 2006/0193082 A1
(43) Pub. Date: Aug. 31, 2006

(54) Tape cartridge

(75) Inventors: Kenji Ota, Ibaraki-shi (JP); Keiji Ban, Ibaraki-shi (JP)

Correspondence Address: BIRCH STEWART KOLASCH & BIRCH, PO BOX 747, FALLS CHURCH, VA, 22040-0747, US

(73) Assignee: HITACHI MAXELL, LTD., Ibaraki-shi (JP)

(21) Appl. No.: 11/355,989

(22) Filed: Feb. 17, 2006

(30) Foreign Application Priority Data
Feb. 21, 2005 (JP) 2005-043489

(51) Int. Cl. G11B 23/02

(52) U.S. Cl. 360/132

(57) ABSTRACT

A tape cartridge according to the invention includes: a main case; a display window opened on a part of an outer circumferential wall of the main case; and a selection piece placed inside the display window for preventing erroneous erase, wherein the selection piece integrally has a cylindrical section and an operation dial each provided in such a way as to face the display window, and rotation shafts provided upper and lower sides thereof, wherein the cylindrical section has a major arc-shaped cylindrical wall formed concentrically around the rotation shafts and a planar wall which connects end sections of the cylindrical wall, and wherein an outer surface of the planar wall and an outer surface of the cylindrical wall opposing the planar wall have a prohibition display signifying an unrecordable state and an admission display signifying a recordable state, respectively.

### BACKGROUND OF THE INVENTION

The present invention relates to a tape cartridge having an erroneous erase preventive structure, and more particularly relates to a tape cartridge having an erroneous erase preventive structure allowing selection between a recordable state and an unrecordable state by rotational operation of a cylinder-shaped selection piece.

The tape cartridge having this kind of erroneous erase preventive structure is known, for example, in JP 07-296558 A (paragraph number 0016, FIG. 1). In this example, a display window is opened on a part of a front wall of a main case, and a cylinder-shaped selection piece is set in the main case in a way of facing the display window, so that upon rotational operation of the selection piece by placing fingertips on a cylindrical wall of the selection piece, the selection piece is switched between a recordable state and an unrecordable state. In the recordable state, a cylindrical outer surface of the selection piece is exposed to the outside from the display window, whereas in the unrecordable state, a planar wall provided at one place on the cylindrical outer surface appears from the display window.

According to the conventional erroneous erase preventive structure having such a shape, the recordable state and the unrecordable state are distinguished by the difference in the outer surface shape of the selection piece.

However, the selection piece is sometimes set in a middle position between the recordable state and the unrecordable state, and in such cases, the middle switching posture is maintained unless outer force is inflicted on the selection piece. In this state, the cylindrical outer surface of the selection piece is exposed from the display window, making it difficult to ascertain if the selection piece is set at the recordable state or the unrecordable state.

Even when the selection piece is kept in the state of being switched to the middle position, no problem arises if an originally intended position of the selection piece is the recordable position. However, if the selection piece is in the middle position when recording onto a magnetic tape should be inhibited, then the selection piece might be easily switched to the recordable position by accidental touch of fingertips upon the selection piece or infliction of outer impact upon the selection piece. In such cases, information signals recorded upon the magnetic tape may be lost or the reliability of the recorded information may be damaged, thereby causing a serious problem.

### SUMMARY OF THE INVENTION

An object of the present invention is to provide a tape cartridge which makes it possible to clearly recognize that a selection piece is appropriately switched to either a recordable posture or an unrecordable posture so as to prevent the selection piece in the state of being switched to a middle position from being loaded onto a tape drive, thereby ensuring prevention of erroneous erase.

More particularly, an object of the present invention is to provide a tape cartridge not only allowing the selected state of the selection piece to be visually checked but also allowing the selected state to be identified by touching the selection piece with fingertips.

In a tape cartridge in the present invention, a display window (8) is opened on a part of a circumferential wall of a main case (1), and a selection piece (9) for erroneous erase prevention is set inside the display window (8) of the main case (1). The selection piece (9) integrally includes a cylindrical section (10) and an operation dial (11) each provided in such a way as to face the display window (8), and rotation shafts (12, 13) provided upper and lower sides of the cylindrical section (10) and the operation dial (11). The cylindrical section (10) has a major arc-shaped cylindrical wall (20) formed concentrically around the rotation shafts (12) and a planar wall (21) which connects end sections of the cylindrical wall (20). Thus, an outer surface of the planar wall (21) and an outer surface of the cylindrical wall (20) opposing the planar wall (21) have a prohibition display (22) signifying an unrecordable state and an admission display (23) signifying a recordable state, respectively (see FIG. 1).

As each of the prohibition display (22) and the admission display (23), visually recognizable displays such as characters and pictographic characters may be selected. The visibly recognizable displays herein include stereoscopic displays such as asperity patterns other than printed displays.

Moreover, each of the prohibition display (22) and the admission display (23) may be made to be haptically recognizable stereoscopic displays such as protrusion and recess (see FIGS. 6A-6C).

In the present invention, the prohibition display (22) signifying an unrecordable state and the admission display (23) signifying a recordable state are respectively provided on the outer surface of the planar wall (21) provided on the cylindrical section (10) of the selection piece (9) and the outer surface of the cylindrical wall (20) opposing the planar wall (21), and therefore visual inspection of the display appearing on the display window (8) allows the switched state of the selection piece (9) to be clearly recognized. Accordingly, when the selection piece (9) is in the state of being switched to a middle position, it is impossible to clearly distinguish the displays (22, 23), which attracts the attention of an user and encourages the user to rotationally operate the selection piece (9) to either appropriate position, that is, an unrecordable state or a recordable state. Therefore, it becomes possible to prevent the tape cartridge from being loaded onto a tape drive with the selection piece (9) being switched to the middle position, and particularly in the case where recording onto the magnetic tape (3) should be prohibited, it becomes possible to reliably prevent the selection piece (9) from being switched to the recordable state against the intension of the user and thereby causing erroneous erase of recorded information.

When the prohibition display (22) and the admission display (23) are formed so as to be displayed as visibly recognizable forms such as characters and pictographic characters, the switched state of the selection piece (9) can be clearly recognized by casting a glance at the prohibition display (22) and the admission display (23), and the display contents can be changed relatively easily in conformity to the difference in language of shipping destinations of the tape cartridge and the difference in display form. Particularly in the case where the respective displays (22, 23) are printed displays, the contents can be changed easily without much costs.

In the case where the prohibition display (22) and the admission display (23) are formed as haptically recognizable stereoscopic displays such as protrusion and recess, the displayed contents can be recognized by touching the respective displays (22, 23) with fingertips in addition to by visual identification, which allows clear recognition of the switched state of the selection piece (9) even under poor lighting environments or for people with visual impairment. Further, rotationally operating the selection piece (9) in the state of putting the fingertips on the prohibition display (22) or the admission display (23) makes it possible to prevent the fingertips from slipping, thereby allowing rotational operation of the selection piece (9) without fail. More particularly, the prohibition display (22) and the admission display (23) carry out a nonslip function and therefore bring an advantage in easy rotational operation of the selection piece (9) particularly in the case where a click means is provided in between the selection piece (9) and the main case (1) and the selection piece (9) has large rotation resistance.

### BRIEF DESCRIPTION OF THE DRAWINGS

The present invention will be further described with reference to the accompanying drawings wherein like reference numerals refer to like parts in the several views, and wherein:

FIG. 1 is an exploded perspective view showing a main part of an erroneous erase preventive structure;

FIG. 2 is a plane view showing the inside of a tape cartridge;

FIGS. 3A and 3B are perspective views explaining the switched state of a selection piece;

FIG. 4 is a cross sectional view taken along line A-A in FIG. 2;

FIG. 5 is a perspective view showing an admission display in another embodiment; and

FIGS. 6A-6C are perspective views showing admission displays formed as stereoscopic displays in other embodiments.

### DETAILED DESCRIPTION OF THE PREFERRED EMBODIMENTS

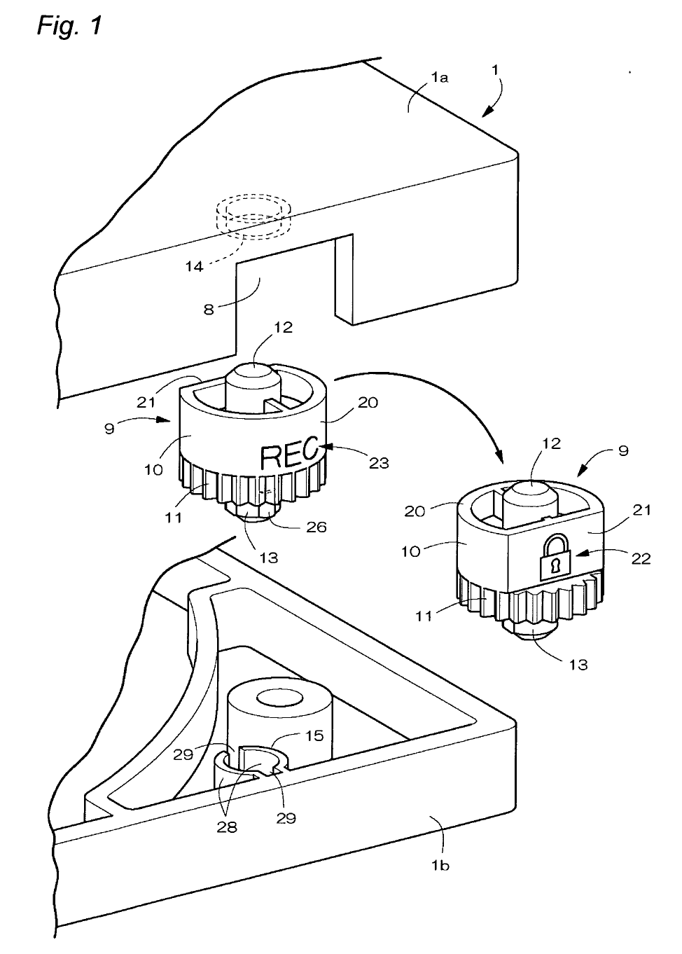

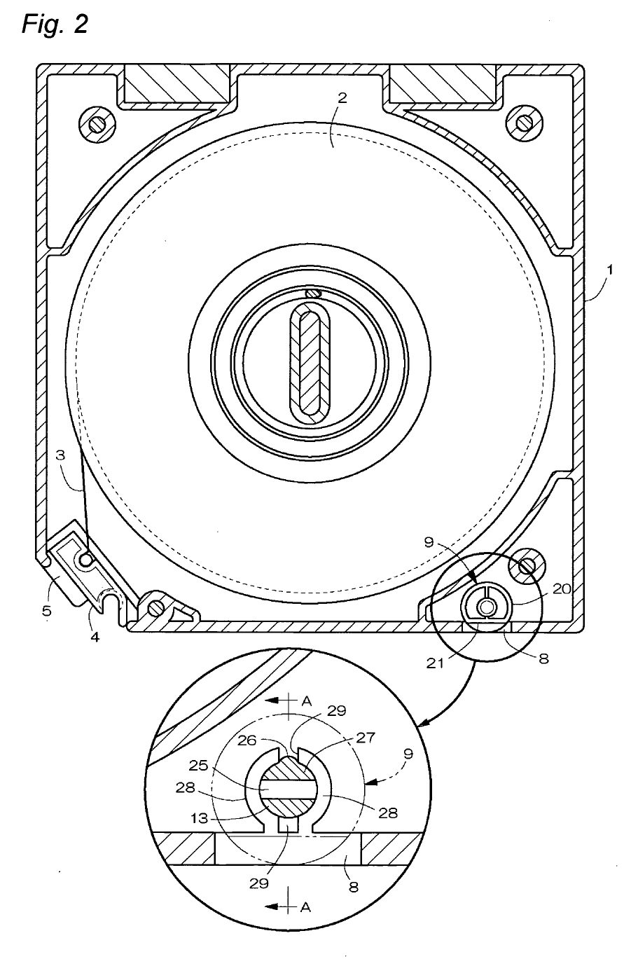

FIG. 1 to FIG. 4 show one embodiment in which the present invention is applied to a single reel-type tape cartridge. As shown in FIG. 2, the tape cartridge includes a main case 1, a tape reel 2 rotatably housed in the main case 1, a long length of a magnetic tape 3 wound around the tape reel 2, a reel lock mechanism for keeping the unused tape reel 2 locked so as to prevent rotation, and an erroneous erase preventive structure. The main case 1 is formed into a square box shape by combining an upper case 1a and a lower case 1b in a lid coupling state.

A leader block 4 is fixed onto an unreeled end of the magnetic tape 3, and by catching the leader block 4 with a loading mechanism on a tape drive side, the magnetic tape 3 can be unreeled from the main case 1 and reeled up onto a take-up reel of the tape dive. The unused leader block 4 is held at a tape outlet 5 opened to a corner (left-hand side in FIG. 2) on the front side of the main case 1.

In order to prevent erroneous erase of information signals recorded onto the magnetic tape 3, a display window 8 is opened to the other side (right-hand side in FIG. 2) of the front wall of the main case 1, and an erroneous erase preventive structure is provided inside the display window 8 of the main case 1. The display window 8 is formed by cutting off the front wall of the upper case 1a at a junction with the lower case 1b in a rectangular shape. The erroneous erase preventive structure includes the selection piece 9 having a cylindrical structure and a click means provided in between the selection piece 9 and the main case 1.

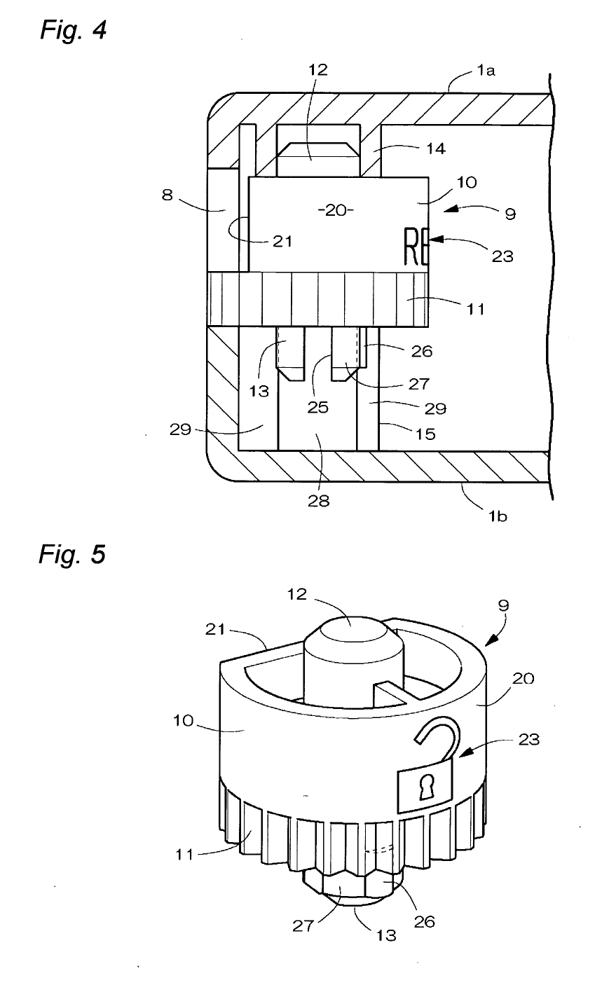

As shown in FIG. 1, the selection piece 9 is a plastic molding integrally having a cylindrical section 10 and an operation dial 11 formed into a gear teeth shape, each provided in such a way as to face the display window 8, and rotation shafts 12, 13 protruding from the upper and lower sides of the cylindrical section 10 and the operation dial 11. As shown in FIG. 4, the upper rotation shaft 12 is supported by a boss 14 provided on the inner surface of the upper case 1a while the lower rotation shaft 13 is supported by a boss 15 with a keyhole-like cross section provided on the inner surface of the lower case 1b, as a result of which the selection piece 9 is supported by the main case 1 in such a way as to be rotatable only around a vertical shaft. The front end of a rotating excursion by the cylindrical section 10 and the operation dial 11 in this state is flush with the front wall of the main case 1 as shown by a virtual line in FIG. 2.

The cylindrical section 10 of the selection piece is formed to have a tunnel-like transverse section by a major arc-shaped cylindrical wall 20 formed concentrically around the rotation shafts 12, 13 and a planar wall 21 which connects end sections of the cylindrical wall 20. In order to clearly show that the selection piece 9 is appropriately selected between a recordable posture and an unrecordable posture, a prohibition display 22 signifying an unrecordable state and an admission display 23 signifying a recordable state are respectively provided on the outer surface of the planar wall 21 and the outer surface of the cylindrical wall 20 opposing the planar wall 21.

As shown in FIG. 1, the prohibition display 22 signifying the unrecordable state is a pictographic character expressing a locked padlock formed by printing in the middle of the outer surface of the planar wall 21. The admission display 23 signifying the recordable state is a character string stating “REC” formed by printing in the middle of the outer surface of the cylindrical wall 20 opposing the planar wall 21.

When the prohibition display 22 faces the display window 8, the top end of a detection pin on the tape drive side is in contact with the planar wall 21 and therefore it is determined, on the tape drive side, that the selection piece 9 is switched to the unrecordable state. When the admission display 23 faces the display window 8, the top end of the detection pin on the tape drive side is received by the major arc-shaped cylindrical wall 20, and therefore it is determined, on the tape drive side, that the selection piece 9 is switched to the recordable state. It should naturally be understood that the user handling the tape cartridge can clearly recognize the switched state of the selection piece 9 by visual inspection of the prohibition display 22 and the admission display 23.

In order to regulate the rotation of the selection piece 9 alternatively switched to the recordable posture or the unrecordable posture and to retain the position of the respective switched postures, the click means is provided with use of the lower rotation shaft 13 and the boss 15 on the side of the lower case 1b. More specifically, as shown in FIG. 2 and FIG. 4, a slit 25 is put in the middle of the rotation shaft 13 to divide the lower rotation shaft 13 into front and rear sections, and a vertical rib 26 is swell-formed on the outer surface of one divided shaft section which serves as an elastic leg 27.

The boss 15 is made of partially circular arc-shaped elastic walls 28 horizontally facing each other and has click grooves 29 formed between the front and rear ends of the elastic walls 28 in which the rib 26 falls. An inner surface diameter size of the boss 15 is set to be equal to or slightly larger than a diameter size of the lower rotation shaft 13. The lower ends of the elastic walls 28 are linked to the bottom wall of the lower case 1b while the front ends of the elastic walls 28 are linked to the front wall of the lower case 1b.

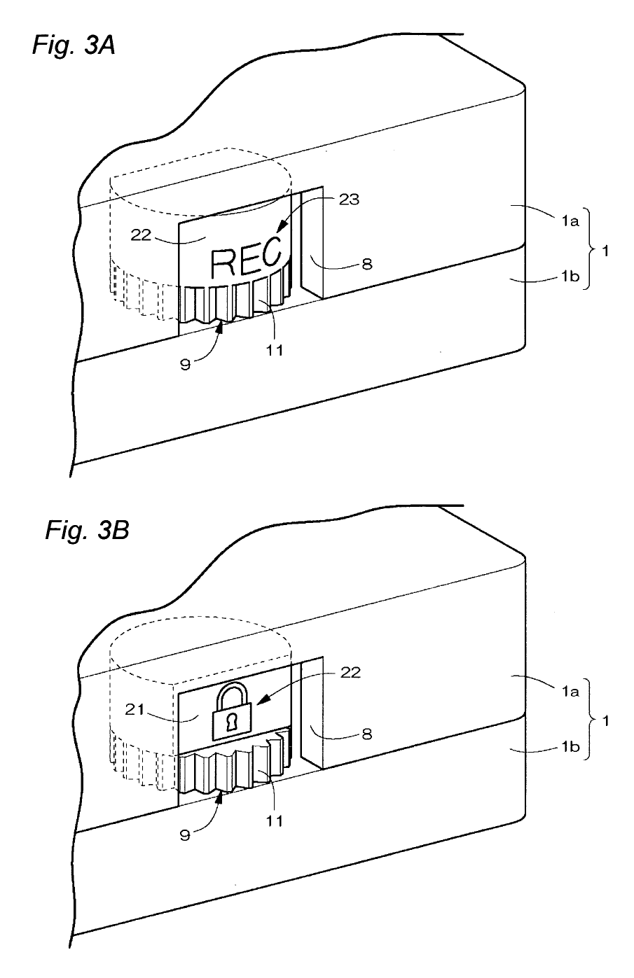

As shown in FIG. 3B, when the prohibition display 22 faces the display window 8, the rib 26 engages with the click groove 29 on the rear side of the case to regulate the rotation of the selection piece 9. When the operation dial 11 is rotationally operated in this state, the elastic leg 27 having the rib 26 and one of the left and right elastic walls 28 are elastically deformed in a direction away from each other, which allows the selection piece 9 to rotate. If the operation dial 11 continues to be rotationally operated almost 180 degrees, then the rib 26 falls in the click groove 29 on the front side of the case so that the rotation of the selection piece 9 is regulated again. At this point, the admission display 23 is exposed to the display window 8 as shown in FIG. 3A.

According to the thus-structured tape cartridge, the switched state of the selection piece 9 can be clearly recognized simply by casting a glance at the prohibition display 22 and the admission display 23 provided on the cylindrical section 10 of the selection piece 9 through the display window 8. In the state that the selection piece 9 is rotationally operated about 90 degrees from either the recordable position or the unrecordable position, each of the prohibition display 22 and the admission display 23 cannot be visibly inspected since both the displays 22, 23 are positioned inside the main case 1. Therefore, the user can recognize that the selection piece 9 is not at a normal switched position, which calls the attention of the user.

As shown in FIG. 5, the admission display 23 may be formed of a pictographic character similar to that of the prohibition display 22. In this embodiment, the pictographic character expressing an unlocked padlock is printed on the cylindrical wall 20 to form the admission display 23. Since other structures are similar to those in the former embodiment, like component members are designated by like reference numerals and description thereof will be omitted. This applies to the subsequent embodiments.

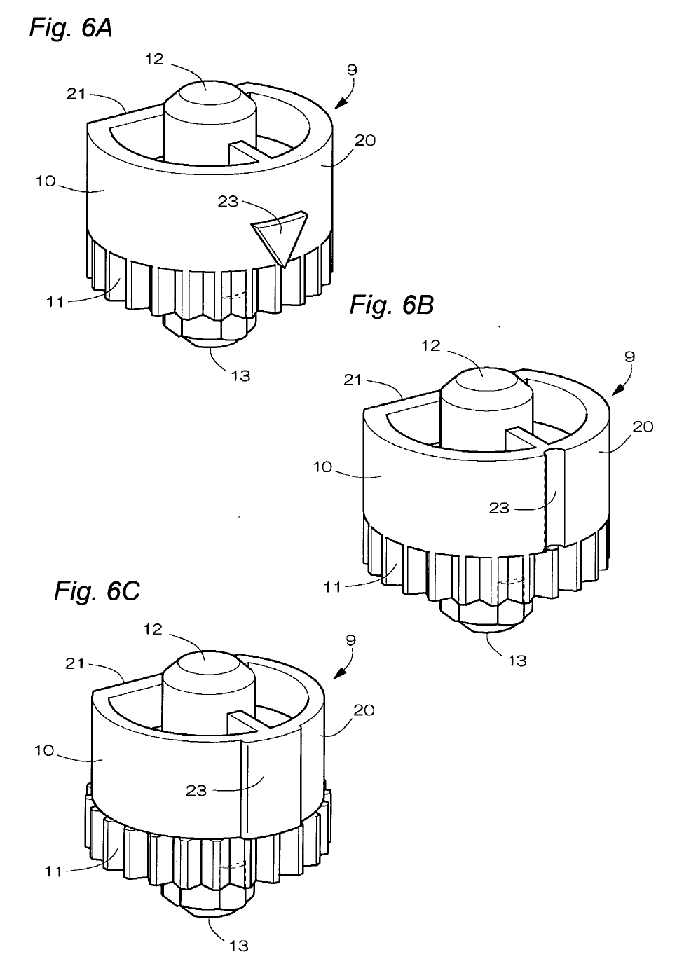

Although the prohibition display 22 and the admission display 23 are both formed by printing in the above embodiments, both the displays 22, 23 may be haptically recognizable stereoscopic displays such as protrusion and recess as shown in FIGS. 6A to 6C.

In FIG. 6A, an inverted triangle-shaped admission display 23 is integrally swell-formed on a middle lower portion of a cylindrical wall 20. Since a prohibition display in this case can be identified by touching the planar wall 21, the swell formation of the prohibition display is not necessarily required. In FIG. 6B, the admission display 23 is formed with a longitudinal groove formed in vertical direction in the middle of the cylindrical wall 20. In FIG. 6C, the admission display 23 is formed with a vertical swollen wall which is formed in a protruding manner in the middle of the cylindrical wall 20. These admission displays 23 formed as stereoscopic displays may be formed in combination with the printing displays disclosed above. According to need, a stereoscopic admission display 23 may be formed on a portion of the operation dial 11.

In the case where the admission display 23 is formed as a stereoscopic display, the switched state of the selection piece 9 can be recognized by touching the admission display 23 with fingertips in addition to by visual inspection, which allows clear recognition of the switched state of the erroneous erase preventive structure even under poor lighting environments or for people with visual impairment.

In addition to the embodiment disclosed above, the present invention is similarly applicable to other types of tape cartridges having a cylindrically structured selection piece 9. The display window 8 should be opened to any region on the outer circumferential wall of the main case 1. A warning display such as striped band patterns and x marks indicating that the switched position of the selection piece 9 is inappropriate may be displayed on the circumferential surface of the cylindrical wall between the prohibition display 22 and the admission display 23.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A tape cartridge, comprising:
a main case;
a display window opened on a part of an outer circumferential wall of the main case; and
a selection piece placed inside the display window of the main case for preventing erroneous erase,
wherein the selection piece integrally has a cylindrical section and an operation dial each provided in such a way as to face the display window, and rotation shafts provided upper and lower sides of the cylindrical section and the operation dial,
wherein the cylindrical section has a major arc-shaped cylindrical wall formed concentrically around the rotation shafts and a planar wall which connects end sections of the cylindrical wall, and
wherein an outer surface of the planar wall and an outer surface of the cylindrical wall opposing the planar wall have a prohibition display signifying an unrecordable state and an admission display signifying a recordable state, respectively.

2. The tape cartridge according to claim 1,
wherein the prohibition display and the admission display are each visually recognizable displays such as characters and pictographic characters.

3. The tape cartridge according to claim 1,
wherein the prohibition display and the admission display are each haptically recognizable stereoscopic displays such as protrusion and recess.
